(19) United States
(12) Patent Application Publication
(10) Pub. No.: US 2026/0022962 A1
(43) Pub. Date: Jan. 22, 2026

(54) GAUGE FOR TESTING A VEHICLE FUEL SYSTEM

(71) Applicant: NATURAL GAS FUEL SYSTEMS, LLC, Roanoke, TX (US)

(72) Inventors: Christopher Culberson, Denton, TX (US); Michael Zimmerman, Trophy Club, TX (US); Robert Gregory Morris, Ferndale, MI (US); Jon Michael Xavier Grabowski, Taylor, MI (US); Joshua Charles Gorsegner, Garden City, MI (US)

(21) Appl. No.: 19/271,454

(22) Filed: Jul. 16, 2025

Related U.S. Application Data
(60) Provisional application No. 63/672,035, filed on Jul. 16, 2024.

(51) Int. Cl. G01F 25/20; B60K 35/28; G01F 23/60

(52) U.S. Cl. CPC G01F 25/20; B60K 35/28; G01F 23/603; B60K 2360/171

(57) ABSTRACT

This disclosure includes systems and methods for testing a vehicle's fuel system. Some systems have a gauge configured to be mounted to a vehicle having a compressed gas fuel system including a compressed gas fuel tank, the gauge having a user interface configured to display fuel pressure within the fuel tank and receive user input to initiate diagnostic testing of the fuel system, and one or more processors configured to, in response to the user input, actuate one or more components of the fuel system, including a solenoid and/or a relay, and display, on the user interface, diagnostic information associated with the actuated one or more components.

### CROSS-REFERENCE TO RELATED APPLICATION

The present application claims priority to U.S. Provisional Application No. 63/672,035, filed Jul. 16, 2024 and entitled “GAUGE FOR TESTING A VEHICLE FUEL SYSTEM,” the entire content of which is incorporated herein by reference.

### BACKGROUND

### A. Field of the Invention

The present invention relates generally to systems and methods for diagnosing and/or configuring a vehicle's (e.g., compressed gas) fuel system, and more specifically but not by way of limitation, to (e.g., vehicle-mounted) systems and methods for actuating one or more of the fuel system's components to test those component(s) and/or for calibrating the vehicle's fuel gauge.

### B. Description of Related Art

A vehicle's fuel system components, and particularly when dealing with a compressed gas fuel system, must operate properly to prevent injury and property damage. To illustrate, a failed fuel tank solenoid can result in undesired fuel flow out of the tank, and a failed regulator can result in excessive pressure in the fuel system, leading to potential rupture and fuel leakage. These and similar instances present a risk of fire or explosion. As another example, should the vehicle's starter-interrupt relay fail, the vehicle's engine may be permitted to start despite one or more faults in the vehicle's fuel system, creating a source of ignition for any leaked fuel and/or allowing operation of an unsafe vehicle.

Therefore, such fuel system components should be frequently tested, including through actuation, to assess their operation. This type of testing, however, usually requires specialized equipment to interface with and actuate components of the fuel system, which is traditionally only available—if at all—at a service center. As a result, such testing may not be performed as often as desired, and identification of faulty fuel system components may be unduly complicated and/or delayed.

Further, calibrating a vehicle's fuel gauge when altering the vehicle's fuel system can pose challenges, particularly when the fuel gauge is designed to work with a liquid fuel system, such as a gasoline or diesel fuel system, and the vehicle is instead equipped with a compressed gas fuel system, such as a compressed natural gas (CNG) or hydrogen fuel system. In a typical liquid fuel system, a fuel level sensor, such as a float-based sensor, is positioned in a fuel tank of the vehicle. As the fuel level in the tank changes, so too does the fuel level sensor's output, via, for example, the float buoyantly rising and falling with the fuel level. Usually, the output from the fuel level sensor is a voltage or a resistance that is read by an electronic control module (ECM) of the vehicle, which, in response, produces a signal indicative of a fuel level in the tank for display by the vehicle's fuel gauge.

When the intended tank and/or fuel level sensor are changed, however, difficulties can arise. For one, the signal produced by the intended fuel level sensor and expected by the ECM often varies between vehicle manufacturers, models, years, and/or the like. Further, correspondence between the intended fuel level sensor's output and the level of fuel in the intended tank is often non-linear, which can be due to, for example, the intended tank having a varying horizontal cross-sectional perimeter. These aspects may be unknown when the intended tank and/or fuel level sensor are changed, complicating calibration of the vehicle's fuel gauge.

Such complications are compounded when the vehicle was intended to be equipped with a liquid fuel system but is instead equipped with a compressed gas fuel system. This is because, for example, such a compressed gas fuel system typically determines tank fuel level based on, e.g., pressure and temperature in the tank, rather than based on a level of liquid in the tank.

### SUMMARY OF THE INVENTION

The present systems and methods can address one or more of these drawbacks. For example, some of the present systems include a gauge configured to be mounted to a vehicle, the gauge including a user interface configured to receive a first user input to initiate diagnostic testing of a compressed gas fuel system and one or more processors configured to, in response to the first user input, actuate one or more components of the fuel system (e.g., a solenoid and/or a relay) and display, on the user interface, diagnostic information associated with the actuated one or more components. In this way, actuation-based testing of the fuel system components can be initiated from the vehicle, obviating the need for specialized off-vehicle equipment and/or a trip to a service center to perform such testing, facilitating the performance of such testing, and/or the like. In some systems, the gauge's user interface is further configured to display one or more parameters of the fuel system, such as a fuel pressure within a tank of the fuel system, a cabinet temperature, a fuel temperature, an engine inlet pressure, an engine load, and/or the like, rendering the gauge useful for monitoring of the fuel system in addition to testing of the fuel system as described above.

Some of the present systems and methods can calibrate a vehicle's fuel gauge using, for example, a fuel system processor, an ECM of the vehicle, and a fuel level interface circuit. To illustrate, the fuel system processor can be configured to transmit a first signal, the fuel level interface circuit can be configured to receive the first signal and transmit a third signal that corresponds to the first signal, the ECM can be configured to receive the third signal and transmit a second signal that corresponds to a fuel level to be displayed on a gauge of the vehicle, and the fuel system processor and/or the fuel level interface circuit can be configured to calibrate the gauge such that a fuel level in a tank corresponding to the first signal is substantially the same as the fuel level corresponding to the second signal by adjusting or generating the correspondence between the first signal and the fuel level in the tank and/or by adjusting the correspondence between the first signal and the third signal.

The fuel system processor (e.g., the fuel system's ECU) can transmit the first signal, which can be a pulse width modulated (PWM) signal, and it can do so regardless of the actual level of fuel in the tank. The fuel level interface circuit can then receive the first signal and, based on the first signal, transmit a third signal that is understandable by the ECM such that the ECM can transmit the second signal in response to receiving the third signal. The third signal can, for example, include a voltage, a current, and/or be indicative of a resistance; the third signal, too, may be a PWM signal. In some instances, the third signal can be sent by the fuel level interface circuit based additionally on a signal received by the fuel level interface circuit (e.g., from the ECM), such as a signal originally intended to be sent to a fuel level sensor for detecting a liquid level in a liquid fuel tank. As a non-limiting illustration, the fuel level interface circuit can generate an effective resistance between the fuel level interface circuit and the ECM, where that effective resistance varies based on the first signal (e.g., a duty cycle thereof) rather than a liquid level in a fuel tank.

In turn, the ECM can receive the third signal and output the second signal (e.g., a controller area network (CAN) bus) corresponding to a fuel level to be displayed on the vehicle's fuel gauge. In some instances, the fuel system processor can receive the second signal and compare the fuel level corresponding to the second signal to a target fuel level and adjust the first signal until the second signal's corresponding fuel level substantially matches the target fuel level.

The fuel level in the vehicle's tank can be determinable. For instance, if the vehicle is equipped with a compressed gas tank, such fuel level can be determined based on, for example, a volume of the tank and a temperature and a pressure of fuel within the tank as indicated in data captured by sensor(s). The fuel system processor (and/or the fuel level interface circuit, in some embodiments) can then align the determinable tank fuel level with the fuel level to be displayed on the vehicle's fuel gauge by, for example, adjusting or generating a correspondence between the first signal and the determinable tank fuel level (and/or adjusting the correspondence between the first signal and the third signal, in some embodiments) such that the fuel level corresponding to the first signal substantially matches the fuel level corresponding to the second signal. For instance, the fuel system processor and/or the fuel level interface circuit can map the first signal to the fuel level corresponding to the second signal and/or map the third signal to the first signal such that the fuel levels corresponding to the first and second signals substantially match.

In one or more of these ways, the vehicle's fuel gauge, and more generally, its fuel level signal, can be calibrated without knowing, for example, its intended fuel level sensor's output and/or its intended fuel tank, and even when a vehicle intended for a liquid fuel system is instead equipped with a compressed gas fuel system. Further, some of the present systems can calibrate a vehicle's fuel level signal regardless of the actual fuel level within the vehicle's tank(s), whether the vehicle is running, and/or the like.

Some of the present systems comprise a gauge configured to be mounted to a vehicle having a compressed gas fuel system including a compressed gas fuel tank, the gauge having a user interface configured to display fuel pressure within the fuel tank and receive a first user input to initiate diagnostic testing of the fuel system, and one or more processors configured to, in response to the first user input, actuate one or more components of the fuel system, including a solenoid and/or a relay, and display, on the user interface, diagnostic information associated with the actuated one or more components. In some systems, the gauge is mounted to the vehicle. In some systems, the gauge is positioned outside of a cab of the vehicle. In some systems, the one or more processors are configured to authenticate a user before responding to the first user input.

In some systems, the user interface is configured to receive a second user input, and the one or more processors are configured to, in response to the second user input, display one or more parameters of the fuel system, including a cabinet temperature, a fuel temperature, an engine inlet pressure, a fuel door position, a fill cap position, and/or an engine load.

In some systems, the user interface is configured to receive a third user input, and the one or more processors are configured to, in response to the third user input, calibrate a fuel level display of the vehicle. In some systems, the fuel level display is displayed on a fuel gauge of the vehicle that is distinct from the gauge. In some systems, the one or more processors are configured to calibrate the fuel level display at least by generating a plurality of first signals, and, for each of at least some of the first signals, receiving a second signal generated by the vehicle based on the first signal and corresponding to a fuel level to be displayed on the fuel level display, and associating the first signal with a fuel level in the tank that is substantially the same as the fuel level to be displayed on the fuel level display corresponding to the second signal.

In some systems, the user interface is configured to receive a third user input, and the one or more processors are configured to, in response to the third user input, activate or deactivate one or more sensors of the vehicle (e.g., of the fuel system thereof, such as a bumper fill or remote fill sensor of the fuel system). In some systems, the user interface is configured to display data captured by the one or more sensors.

In some systems, the user interface is configured to (e.g., in response to receiving a fourth user input) display a fuel pressure downstream of a regulator of the fuel system, and indicate whether the fuel pressure downstream of the regulator is above or below a target fuel pressure. In some systems, the target fuel pressure is based at least in part on the fuel pressure within the fuel tank.

Some of the present methods for diagnosing a fuel system of a vehicle comprise displaying, via a user interface of a gauge mounted to the vehicle, the vehicle having a compressed gas fuel system including a compressed gas fuel tank, a fuel pressure within the fuel tank, receiving, via the user interface, a first user input to initiate diagnostic testing of the fuel system, actuating, in response to the first user input, one or more components of the fuel system, including a solenoid and/or a relay, and displaying, on the user interface, diagnostic information associated with the actuated one or more components. In some methods, the gauge is positioned outside of a cab of the vehicle. Some methods comprise authenticating a user before responding to the first user input.

Some methods comprise receiving, via the user interface, a second user input, and, in response to the second user input, displaying one or more parameters of the fuel system, including a cabinet temperature, a fuel temperature, an engine inlet pressure, and/or an engine load.

Some methods comprise receiving, via the user interface, a third user input, and, in response to the third user input, calibrating a fuel level display of the vehicle. Some methods comprise displaying the fuel level display on a fuel gauge of the vehicle that is distinct from the gauge. In some methods, calibrating the fuel level display comprises generating a plurality of first signals, and, for each of at least some of the first signals, receiving a second signal based on the first signal and corresponding to a fuel level to be displayed on the fuel level display, and associating the first signal with a fuel level in the tank that is substantially the same as the fuel level to be displayed on the fuel level display corresponding to the second signal.

Some methods comprise receiving, via the user interface, a third user input, and, in response to the third user input, activating or deactivating one or more sensors of the vehicle (e.g., of the fuel system thereof). Some methods comprise displaying on the user interface data captured by the one or more sensors.

Some methods comprise (e.g., in response to a fourth user input) displaying, on the user interface, a fuel pressure downstream of a regulator of the fuel system, and indicating, on the user interface, whether the fuel pressure downstream of the regulator is above or below a target fuel pressure. In some methods, the target fuel pressure is based at least in part on the fuel pressure within the fuel tank.

Some of the present systems for calibrating a fuel gauge of a vehicle comprise a fuel system processor configured to transmit a first signal, and receive, from an electronic control module (ECM) of the vehicle, a second signal that corresponds to a fuel level to be displayed on a gauge of the vehicle, and a fuel level interface circuit in electrical communication between the fuel system processor and the ECM, the fuel level interface circuit configured to receive the first signal, and transmit a third signal that corresponds to the first signal to the ECM, causing the ECM to transmit the second signal, wherein the fuel system processor and/or the fuel level interface circuit are configured to calibrate the gauge such that a fuel level in a tank corresponding to the first signal is substantially the same as the fuel level corresponding to the second signal by adjusting or generating the correspondence between the first signal and the fuel level in the tank and/or by adjusting the correspondence between the first signal and the third signal. In some systems, the fuel system processor is configured, during calibration of the gauge, to transmit the first signal regardless of the actual fuel level in the tank. In some systems, the tank comprises a compressed gas tank.

In some systems, the fuel system processor and the fuel level interface circuit are mounted to the vehicle, and the system comprises a user interface that is mounted to the vehicle and configured to receive a user input and to cause, based at least in part on the user input, calibration of the gauge.

In some systems, the first signal comprises a pulse width modulated (PWM) signal. In some systems, the second signal comprises a controller area network (CAN) bus signal. In some systems, the third signal comprises a voltage, a current, and/or is indicative of a resistance. In some systems, the third signal comprises a PWM signal. In some systems, the fuel level interface circuit provides an effective resistance between the ECM and the fuel level interface circuit, where the effective resistance varies based on the first signal received by the fuel level interface circuit.

In some systems, for each of a plurality of target fuel levels, the fuel system processor is configured to vary the transmitted first signal until the fuel level corresponding to the received second signal is substantially the same as the target fuel level. In some systems, the target fuel levels include a fuel level that is within 10% of an empty fuel level, a fuel level that is within 10% of a full fuel level, and a plurality of fuel levels that are between the empty fuel level and the full fuel level.

In some systems, the second signal comprises a plurality of second signals that correspond to a plurality of fuel levels to be displayed on the gauge, including a fuel level that is within 10% of an empty fuel level, a fuel level that is within 10% of a full fuel level, and a plurality of fuel levels that are between the empty fuel level and the full fuel level.

Some of the present methods for calibrating a fuel gauge of a vehicle comprise, with a fuel system processor, transmitting a first signal to a fuel level interface circuit, with the fuel level interface circuit, receiving the first signal, and, in response to receiving the first signal, transmitting a third signal that corresponds to the first signal to an ECM of the vehicle, with the ECM of the vehicle, receiving the third signal, and, in response to receiving the third signal, transmitting a second signal that corresponds to a fuel level to be displayed on a gauge of the vehicle, and, with the fuel system processor and/or the fuel level interface circuit, receiving the second signal, and calibrating the fuel gauge such that a fuel level in a tank corresponding to the first signal is substantially the same as the fuel level corresponding to the second signal by adjusting or generating the correspondence between the first signal and the fuel level in the tank and/or by adjusting the correspondence between the first signal and the third signal. In some methods, the tank comprises a compressed gas tank.

In some methods, the fuel system processor transmits the first signal regardless of the actual fuel level in the tank. In some methods, an actual fuel level in the tank of the vehicle does not substantially change during performance of the method. In some methods, an engine of the vehicle is not running during performance of the method.

In some methods, the fuel system processor and the fuel level interface circuit are mounted to the vehicle, and the system comprises a user interface that is mounted to the vehicle and configured to receive a user input and to cause, based at least in part on the user input, calibration of the gauge.

In some methods, the first signal comprises a pulse width modulated (PWM) signal. In some methods, the second signal comprises a controller area network (CAN) bus signal. In some methods, the third signal comprises a voltage, a current, and/or is indicative of a resistance. In some methods, the third signal comprises a PWM signal. In some methods, the fuel level interface circuit provides an effective resistance between the ECM and the fuel level interface circuit, where the effective resistance varies based on the first signal received by the fuel level interface circuit.

Some methods comprise, for each of a plurality of target fuel levels, varying, with the fuel system processor, the transmitted first signal until the fuel level corresponding to the received second signal is substantially the same as the target fuel level. In some methods, the target fuel levels include a fuel level that is within 10% of an empty fuel level, a fuel level that is within 10% of a full fuel level, and a plurality of fuel levels that are between the empty fuel level and the full fuel level.

In some methods, the second signal comprises a plurality of second signals that correspond to a plurality of fuel levels to be displayed on the gauge, including a fuel level that is within 10% of an empty fuel level, a fuel level that is within 10% of a full fuel level, and a plurality of fuel levels that are between the empty fuel level and the full fuel level.

Some methods comprise calibrating a fuel gauge of a second vehicle at least by storing the correspondence between the first signal and the fuel level in the tank in a memory coupled to a fuel system processor of the second vehicle.

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees, and substantially parallel includes parallel), as understood by a person of ordinary skill in the art. In any disclosed embodiment, the terms “substantially,” “approximately,” and “about” may be substituted with “within 10% of” what is specified.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and containing”) are open-ended linking verbs. As a result, an apparatus that “comprises,” “has,” “includes,” or “contains” one or more elements possesses those one or more elements but is not limited to possessing only those one or more elements. Likewise, a method that “comprises,” “has,” “includes,” or “contains” one or more steps possesses those one or more steps but is not limited to possessing only those one or more steps.

Any embodiment of any of the apparatuses and methods can consist of or consist essentially of—rather than comprise/have/include/contain-any of the described elements, features, and/or steps. Thus, in any of the claims, the phrase “consisting of” or “consisting essentially of” can be substituted for any of the open-ended linking verbs recited above to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate identical structures. Rather, the same reference numbers may be used to indicate similar features or features with similar functionalities, as may non-identical reference numbers.

FIG. 1 depicts a vehicle including one of the present fuel systems.

FIG. 2 depicts compressed gas tanks of the fuel system, shown housed in a cabinet of the fuel system.

FIG. 3 is a schematic of the fuel system showing additional components of the fuel system, including a pressure gauge as well as a starter-interrupt relay, a solenoid, and regulators, each of which can be diagnosed through user interaction with the pressure gauge.

FIGS. 4A-4F depict various screens displayable by a user interface of the pressure gauge that can be used monitor and diagnose the fuel system.

FIG. 5A depicts various screens displayable by the user interface of the pressure gauge that can be used to monitor the fuel system.

FIG. 5B depicts various screens displayable by the user interface of the pressure gauge that can be used to diagnose the fuel system.

FIG. 6 is a schematic of the fuel system showing additional components of the fuel system, including a fuel system processor and a fuel level interface circuit that, in conjunction with an ECM of the vehicle, can calibrate a fuel gauge of the vehicle.

FIGS. 7A and 7B each show a fuel tank and fuel level sensor of a liquid fuel system.

FIG. 8 is a flow chart depicting one of the present methods for calibrating a fuel gauge of the vehicle.

FIG. 9 shows an example correspondence between fuel levels in the tanks of the vehicle and first signals generated by the fuel system processor that can be adjusted or generated during calibration of the vehicle's fuel gauge.

### DETAILED DESCRIPTION

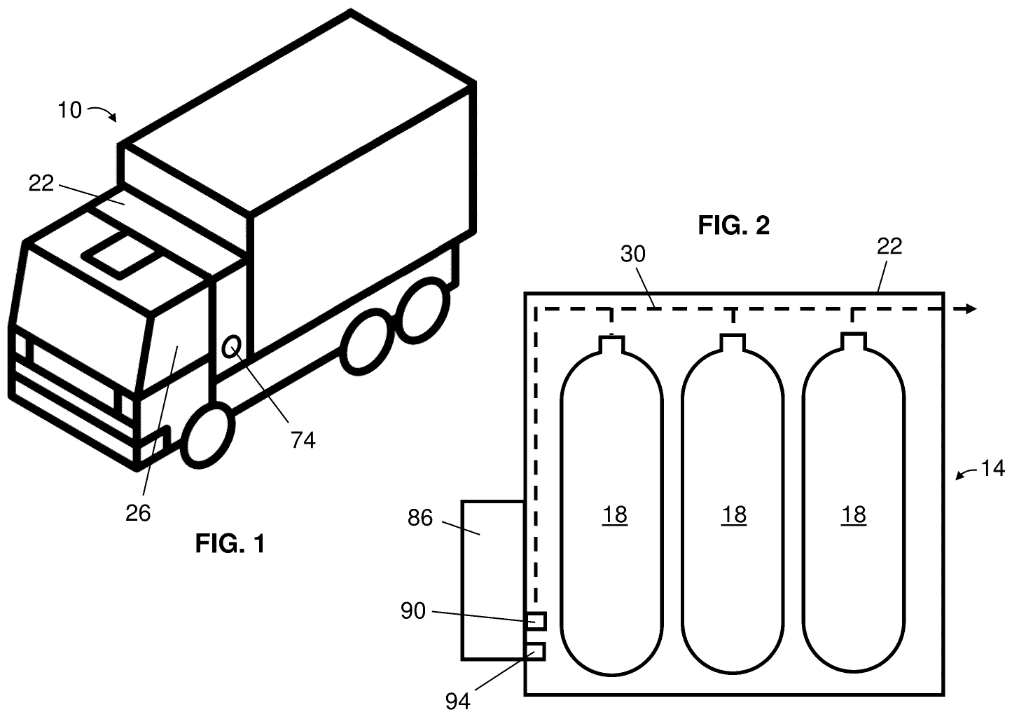

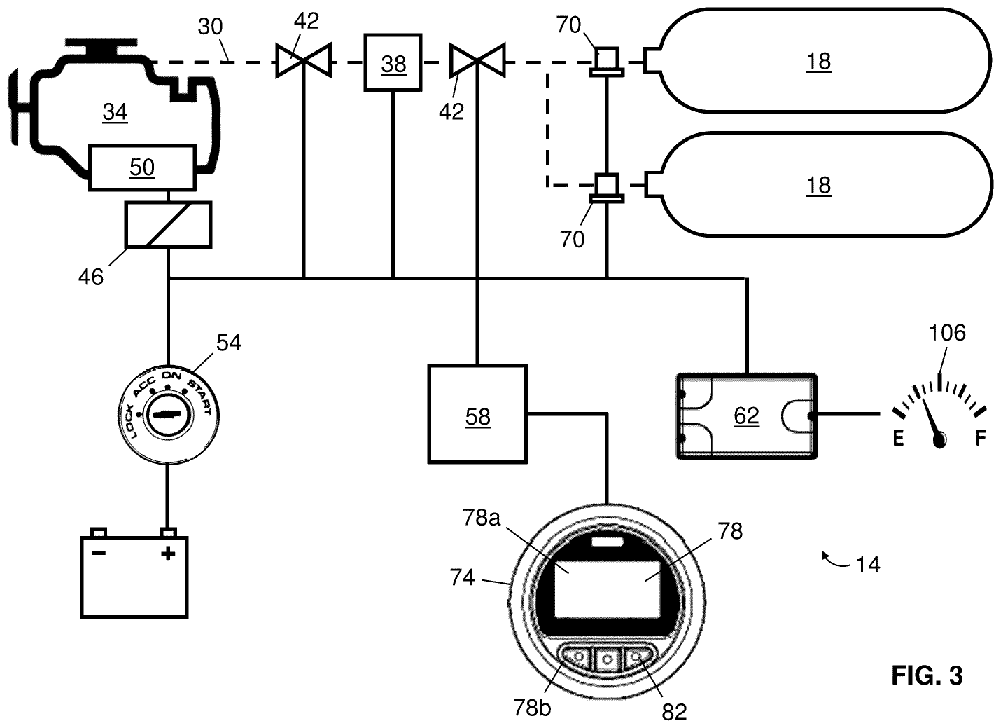

Referring now to the drawings, FIG. 1 shows a vehicle 10 including one of the present fuel systems 14. As shown, vehicle 10 is a commercial vehicle, such as a box truck, tractor truck, garbage truck, bus, and/or the like. The present fuel systems (e.g., 14) are usable with other vehicles, however, including passenger vehicles such as cars and trucks. Referring additionally to FIG. 2, fuel system 14 is a compressed gas fuel system, such as a CNG fuel system or a hydrogen fuel system. To illustrate, fuel system 14 includes one or more compressed gas tanks 18 (e.g., 1, 2, 3, 4, 5, or more compressed gas tanks), which, in some embodiments, can be housed in a cabinet 22. Whether or not housed in cabinet 22, compressed gas tanks 18 can be mounted to vehicle 10 in any suitable location, such as behind a cab 26 of the vehicle (as shown), underneath the vehicle, on a roof of the vehicle, on a tailgate of the vehicle (e.g., when the vehicle is a garbage truck), in a trunk of the vehicle, and/or the like. Fuel system 14 includes fuel conduits 30—indicated in the figures by dashed lines—for delivering fuel from compressed gas tanks 18 to an engine (e.g., 34, FIG. 3) or, in some embodiments, a fuel cell, of the vehicle.

Referring additionally to FIG. 3, fuel system 14 includes one or more components for controlling fuel flow from compressed gas tanks 18 to vehicle 10's engine 34. As one example, fuel system 10 can include one or more solenoids 38 that are each actuatable to selectively block or allow fuel flow through one or more fuel conduits 30, from one or more compressed gas tanks 18, and/or the like. As a specific example, a solenoid 38 can be installed on an outlet of a compressed gas tank 18 as a “shut off” valve. That solenoid can then be actuated to block or allow fuel flow from the compressed gas tank. Fuel system 14's solenoid(s) 38 can be configured to block such fuel flow if, for instance, vehicle 10 is not in use, the vehicle is involved in a collision, temperature within and/or around or pressure within fuel system 14 exceeds a threshold temperature and/or pressure, there is a malfunction in the fuel system, and/or the like. By controlling this fuel flow, in these instances and others, solenoid(s) 38 can limit undesired fuel flow out of compressed gas tanks 18 and/or other fuel system 14 components, thereby mitigating the risk of fire, explosion, and/or the like.

As another example, fuel system 14 can also include one or more regulators 42. Each of regulator(s) 42 can control a pressure within fuel system 14 upstream and/or downstream of the regulator such that that pressure is within a desired pressure range or above or below a targeted pressure. As one example, a regulator 42 can be one that reduces pressure of fuel from one or more of compressed gas tanks 18 or other upstream location in fuel system 14 so that, for instance, the fuel can be consumed by engine 34, or, in other embodiments, a fuel cell. Should that regulator fail, components downstream of the regulator (e.g., fuel conduits 30, such as one or more fuel rails of vehicle 10, the vehicle's fuel injectors or other engine 34 components, and/or the like) can also fail, again leading to undesired fuel flow and the attendant risk of explosion, fire, and/or the like.

Fuel system 14 can further include one or more relays, such as a starter interrupt relay 46. Relay 46 can be actuated to prevent (or allow) starter 50 to turn engine 34 by, for instance, breaking (or allowing) continuity from ignition switch 54 to the starter. In this way, if a fuel system 14 fault is detected, such as a fuel pressure and/or temperature that is too high, a fuel leak, a failed solenoid or regulator (e.g., 38 or 42), and/or the like, relay 46 can be used to prevent further damage that might be caused by starting engine 34. Relay 46 can also be used to prevent engine starting when, for example, vehicle 10 is being fueled or defueled, when door(s) (86, described below) of fuel system 14 are open, and/or the like.

Actuatable components of fuel system 14—including solenoid(s) 38 and/or relay(s) (e.g., 46)—can be controlled by one or more processors, such as a fuel system processor 58, an ECM 62 and/or 66, and/or the like. ECM is used broadly to encompass vehicle control modules, including body control modules (“BCMs”) and powertrain control modules (“PCMs”). Such control can be facilitated through data captured by one or more sensors 70, including data indicating any of the conditions described above are present. To illustrate using solenoid(s) 38, if data captured by one or more of sensor(s) 70 indicates that a pressure and/or temperature within fuel system 14 exceeds a threshold pressure and/or temperature, the processor(s) can control one or more of the solenoid(s) to block fuel flow from tanks 18 to engine 34.

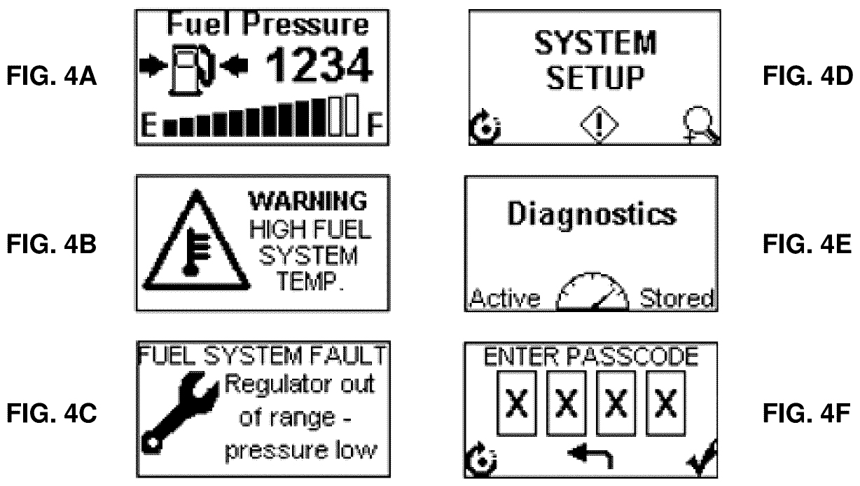

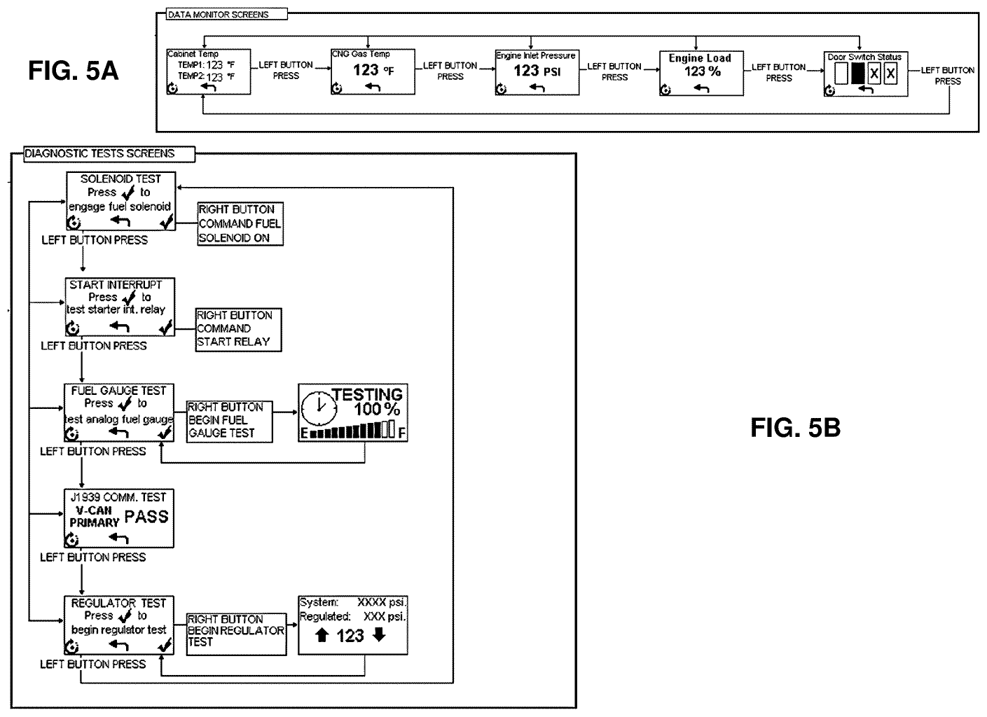

Shown in FIGS. 1 and 3, fuel system 14 includes a gauge 74 mounted to vehicle 10 that is configured to monitor fuel system 14 and test its components. As depicted, gauge 74 is mounted outside of cab 26, and particularly, on or within cabinet 22. In other embodiments, however, a gauge (e.g., 74) can be mounted to a vehicle (e.g., 10) in any suitable location, including within a cab (e.g., 26) of the vehicle. Gauge 74 can have a user interface 78. User interface 78 can include a display portion 78a for displaying information to a user and a user-input portion 78b for allowing the user to navigate through the gauge's various displays and activate its various functions (see FIGS. 4A-5B). For example, user-input portion 78b can include physical buttons 82. In some embodiments, a user interface (e.g., 78) can integrate its display portion (e.g., 78a) and user-input portion (e.g., 78b); to illustrate, the user interface can be a touch screen.

Gauge 74 can monitor fuel system 14 by, for example, displaying a fuel pressure within the fuel system. An exemplary fuel pressure display is depicted in FIG. 4A, which shows the pressure of fuel in tanks 18. The displayed fuel pressure within fuel system 14 can-additionally or alternatively-include a pressure in a fuel conduit 30, a pressure upstream or downstream of a solenoid 38, a pressure upstream or downstream of a regulator 42, and/or the like. To illustrate with additional reference to FIG. 5A, the displayed fuel pressure can include a pressure downstream of the regulator that supplies fuel to engine 34, such as an engine inlet pressure. These displayed fuel pressures can be indicated in data captured by one or more of sensor(s) 70. Gauge 74 can also display fuel system 14 temperatures, such as a temperature within or around cabinet 22 (FIG. 5A) and/or a temperature of fuel within the fuel system, whether in tanks 18, in a fuel conduit 30, upstream or downstream of a solenoid 38, a regulator 46, and/or the like, and/or the like, which likewise can be indicated in data captured by one or more of sensor(s) 70.

Other parameters of fuel system 14 can be displayed by gauge 74. For example, gauge 74 can display a fuel level in tanks 18 (FIG. 4A). Being a compressed gas fuel system 14, that fuel level can be determined based on a temperature and pressure of fuel within tanks 18 as indicated in data captured by one or more of sensor(s) 70. While, in FIG. 4A, the fuel level is displayed as a level of fuel between empty and full, the fuel level can, additionally or alternatively, be displayed as an estimated distance (e.g., in miles or kilometers) to empty.

Gauge 74 can also be configured to display the status of fuel system 14's door switches (FIG. 5A). To illustrate and as shown in FIG. 1, fuel system 14 (e.g., cabinet 22 thereof) can include a door 86 that allows access to fuel system 14 components, such as one or more ports (e.g., 90) for filling or emptying tanks 18, the tanks and fuel conduits 30 connecting the tanks to one another and/or to engine 34, shut-off valve(s) for preventing fuel flow from tanks 18, and/or the like. Fuel system 14 can further include a door switch 94 that indicates whether door 86 is open or closed. If, for example, door switch 94 indicates that door 86 is open, fuel system 14 (e.g., a processor (e.g., 58, 62, and/or 66, and/or a processor of gauge 74) thereof) can provide an alert to an operator, prevent engine 34 from starting (e.g., via control of starter interrupt relay 46), and/or the like. Depicted in FIG. 5A, exemplary statuses for a door switch 94 displayable by gauge 74 can include door open (e.g., an unfilled rectangle), door closed (e.g., a filled rectangle), or that the door switch is disabled (e.g., an “X”).

Further shown in FIG. 5A, fuel system 14 parameters displayable by gauge 74 can include those related to engine 34, such as engine load, engine speed (e.g., in RPM), engine inlet fuel pressure, and/or the like. In some instances, such parameters can be obtained from one or more ECMs (e.g., 62, 66, and/or the like) of vehicle 10, including over a CAN or other bus of vehicle 10. The above-discussed parameters of fuel system 14 are not limiting on the parameters that can be displayed by gauge 74.

Referring now to FIGS. 4B and 4C, gauge 74 can also display fuel system 14 warnings or faults. Such warnings or faults can include, for example, high temperature (or high pressure) within a portion of fuel system 14, such as within cabinet 22, a tank 18, a conduit 30, and/or the like, door 86 open, caps covering fill or defuel ports (e.g., 90) not installed, regulated fuel pressure out of range (e.g., whether above or below a desired value or range), a sensor 70 error, and/or the like. The warnings or faults can also indicate engine 34 shutdown, such as that caused by low engine speed or shutdown of fuel system 14's supply of fuel to the engine. Further, the warnings or faults can be stored in a memory, including both past and active warnings or faults, facilitating diagnosis of fuel system 14.

Conditions for a warning or fault can be indicated in, for example, data captured by sensor(s) 70, data transmitted over a CAN or other bus of vehicle 10, and/or the like, and that data can be evaluated by one or more processors (e.g., 58, 62, 66, a processor of gauge 74, and/or the like) to determine the presence of such conditions. To illustrate, the processor(s) can determine whether temperature within fuel system 14 is too high by comparing temperature data captured by sensor(s) 70 to a threshold temperature and, if so, cause gauge 74 to display the high-temperature warning.

Gauge 74 can also be configured to receive a user input (e.g., a button 82 press) to initiate diagnostic testing of fuel system 14. Illustrative screens of display portion 78a for facilitating such testing are shown in FIG. 5B. In response to the user input, one or more processors (e.g., 58, 62, 66, a processor of gauge 74, and/or the like) can actuate one or more components of fuel system 14, such as a solenoid 38 and/or a relay 46, and gauge 74 can display diagnostic information associated with the actuated component(s).

To illustrate, gauge 74 can receive a user input to diagnose a solenoid 38. In response, the processor(s) can command the solenoid to, for example, open, close, cycle, and/or the like. The solenoid's state (e.g., opened or closed) can be monitored during its diagnosis by, for example, reading that state from a CAN or other bus of the vehicle, based on data captured by sensor(s) 70, such as a fuel pressure in fuel system 14 upstream and/or downstream of the solenoid, and/or the like. Gauge 74 can then display diagnostic information associated with the solenoid, such as the solenoid's state, whether the solenoid followed the command (e.g., whether the solenoid's state is in the commanded state), and/or the like.

As another example, user input received by gauge 74 can initiate diagnostic testing of starter interrupt relay 46. Like for solenoid(s) 38, the processor(s) can command the relay to open, close, cycle, and/or the like. The state of the relay can be monitored based on data retrieved from a CAN or other bus of vehicle 10, by the processor(s) assessing continuity through the relay to starter 50, and/or the like. Diagnostic information associated with the relay that can be displayed by gauge 74 can, similarly to solenoid(s) 38, including the relay's state, whether the relay followed the command, and/or the like.

In these ways and others, actuation-based testing of fuel system 14 components can be initiated from vehicle 10 via vehicle-mounted gauge 74, obviating the need for specialized off-vehicle equipment and/or a trip to a service center to perform such testing. This encourages, as well as facilitates, frequent testing of safety-critical components of fuel system 14, like solenoid(s) 38 and/or starter interrupt relay 46.

Gauge 74 can further facilitate on-vehicle diagnostic testing of other fuel system 14 components, such as a regulator 42. To illustrate, upon user input, the processor(s) can compare actual fuel pressure supplied by the regulator—e.g., as indicated in data captured by sensor(s) 70—and desired fuel pressure supplied by the regulator. Based on that comparison, gauge 74 can indicate whether the actual fuel pressure deviates from the desired fuel pressure, such as by displaying an “up” arrow when the actual fuel pressure is below the desired fuel pressure or a “down” arrow when the actual fuel pressure is above the desired fuel pressure (FIG. 5B), or vice versa. The desired fuel pressure can be a range, such as a range based on a target fuel pressure, e.g., a range that encompasses an amount below the target fuel pressure (e.g., 10, 9, 8, 7, 6, 5, 4, 3, 2, 1, or even 0 psi below the target fuel pressure) as well as an amount above the target fuel pressure (e.g., 10, 9, 8, 7, 6, 5, 4, 3, 2, 1, or even 0 psi above the target fuel pressure) (e.g., from the target fuel pressure to 2 pounds per square inch (“psi”) above the target fuel pressure). If the actual fuel pressure is above or below (e.g., above) the desired or target fuel pressure by a threshold amount (e.g., 1, 2, 3, 4, 5, 6, 7, 8, 9, 10, or more) (e.g., above by 5 psi), gauge 74 can alert the user, including through a warning or fault and/or other means, such as by illuminating a warning light of the gauge (e.g., an LED, such as a red LED). The desired or target fuel pressure can be determined (e.g., by fuel system processor 58) based on, for example, a fuel pressure, temperature, and/or the like within fuel system 14 (e.g., a fuel pressure in tank(s) 18). Further, the desired or target fuel pressure can be displayed by gauge 74.

Another vehicle 10 component that gauge 74 can be used to test is the vehicle's fuel gauge (e.g., 106, described below). In particular, a user of gauge 74 can provide input to gauge 74 that the processor(s) respond to by signaling the vehicle's fuel gauge to indicate certain vehicle fuel levels (e.g., from empty to full, including any value therebetween) and/or to sweep a certain range therebetween. This can identify any mismatches between the signaled vehicle fuel levels and those displayed by the vehicle's fuel gauge and potential faults associated therewith. Beyond that, gauge 74 can receive user input to disable (or enable) sensor(s) 70, such as door sensor(s) (e.g., 94), fill sensors (e.g., to detect whether port(s) 90 are uncovered or covered, such as by cap(s)), pressure and/or temperature sensors, and/or the like, of fuel system 14, which is advantageous to, for example, configure a fuel system 14 without said senor(s), eliminate signals from failed said sensor(s), and/or the like.

Referring additionally to FIG. 4F, gauge 74's functionality, given at least the impact on fuel system 14 and/or vehicle 10 that it can have, can include password protection. To illustrate, a user may need to enter a password to access certain functions of gauge 74, such as those for implementing one or more of the diagnostic tests or controls of fuel system 14 component(s) described above, the vehicle fuel gauge (e.g., 106) calibration described below, and/or the like.

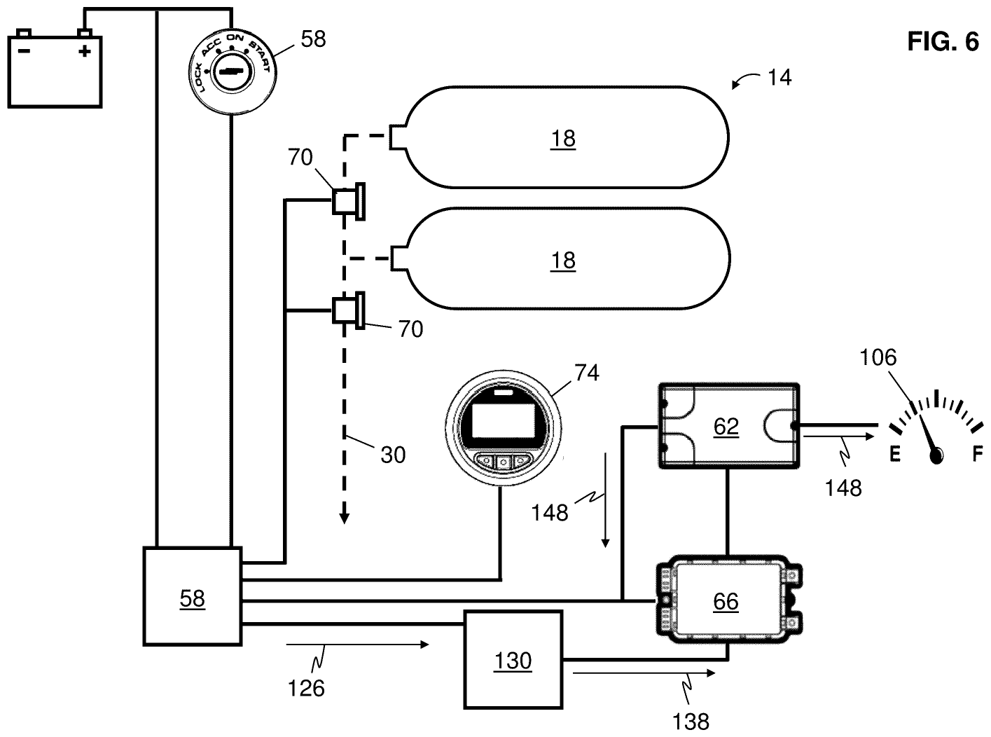

Referring additionally to FIG. 6, gauge 74 can, in response to a user input, initiate calibration of a fuel gauge 106 of vehicle 10 that is distinct from gauge 74. To illustrate, gauge 106 can be part of the vehicle's instrument cluster, whether as a physical gauge or one displayed on a screen. Gauge 106 can receive a fuel level signal (e.g., a CAN bus signal) from one or more of vehicle 10's ECMs, such as ECM 62 and/or 66, indicating the level of fuel to be displayed by the gauge.

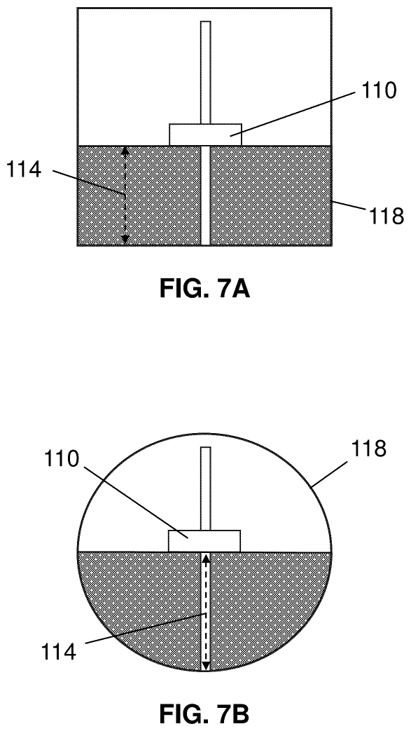

In some vehicles (e.g., 10), gauge 106 and the ECM(s) can be designed to work with a liquid fuel system, such as a diesel or gasoline fuel system. Referring additionally to FIG. 7A, in that configuration, an ECM could receive a signal from a fuel level sensor 110, such as a float-based sensor as shown, indicating a liquid level 114 in the vehicle's liquid fuel tank 118. That signal could be, for instance, a voltage, a current, and/or be indicative of a resistance. To illustrate, fuel level sensor 110 could be a resistance-based fuel level sensor in which the ECM sends a signal to the fuel level sensor that generates a return signal, varied by the fuel level sensor's resistance, from the fuel level sensor to the ECM. The ECM could then, through programming based on, e.g., the type and range of the liquid level signal from sensor 110 and the geometry of tank 118, generate a corresponding fuel level (e.g., empty to full) signal to be displayed by gauge 106.

When the vehicle's fuel system is changed, however, the ECM(s) programming, specifically, how the ECM(s) map input liquid level signals to output fuel level signals, may no longer be accurate. To illustrate, a different fuel level sensor (e.g., 110) may produce a liquid level signal of a different type or a different range. Further, a different tank (e.g., 118) may have a different geometry such that the relationship between a liquid level (e.g., 114) in the tank and an amount of fuel in the tank—i.e., a fuel level—is changed. As a simple example, a fuel tank having a rectangular cross-section (FIG. 7A) may provide for a linear relationship between liquid level and amount of fuel in the tank, whereas a fuel tank having a circular cross-section (FIG. 7B) may provide for a non-linear relationship between liquid level and amount of fuel in the tank, such as one in which changes in liquid level when the tank is near half full correspond to larger changes in amount of fuel as compared to changes in liquid level when the tank is near full or near empty.

These issues can be exacerbated when the vehicle's fuel system is replaced with a compressed gas fuel system. For instance, such compressed gas fuel systems typically do not employ sensors (e.g., 110) that measure a liquid level (e.g., 114) within a tank (e.g., 118). Rather, they calculate the amount of fuel in the vehicle's tank(s) based on, e.g., the pressure and temperature of the fuel in the tanks. To illustrate, fuel system 14 includes sensor(s) 70 configured to capture data indicative of at least a temperature and pressure of fuel within tanks 18, and a fuel system processor 58 configured to calculate the amount of fuel in tanks 18 based on that data, such as by using the ideal gas law corrected by a compressibility factor.

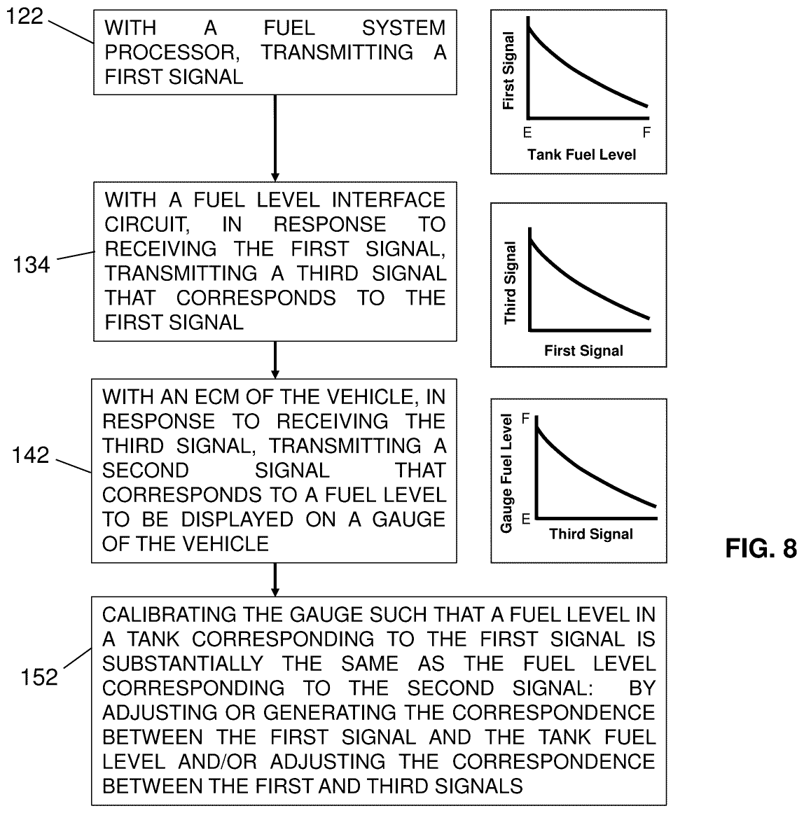

Referring additionally to FIG. 8, embodiments of the present fuel systems (e.g., 14) can be used to calibrate a fuel gauge (e.g., 106), and more generally, a fuel level signal (e.g., a second signal 148), of a vehicle (e.g., 10), despite changes to the vehicle's fuel system. To begin, at step 122, fuel system processor 58 can transmit a first signal 126. This first signal can correspond to a fuel level in tank(s) 18 of vehicle 10. And the fuel level in tank(s) 18 can be determinable based on, for example, the temperature and pressure of fuel in tank(s) 18 as indicated in data captured by sensor(s) 70. This fuel level can also be simulated; for instance, fuel system processor 58 can transmit first signal 126 corresponding to the fuel level in tank(s) 18 regardless of the actual fuel level in the tank(s). The correspondence between first signal 126 and the fuel level in tank(s) 18 can be known, and in some instances, adjustable, and that correspondence can, for example, be stored in a memory (e.g., as a table, a function, and/or the like). In fuel system 14, first signal 126 can be a pulse-width modulated (PWM) signal.

In some embodiments, first signal 126 may not be of the type, range, and/or the like expected by the vehicle's ECM(s) (e.g., 62 and/or 66). For example, those ECM(s) may expect certain voltages, currents, and/or signals indicative of certain resistances, such as from a liquid-level-sensing fuel level sensor (e.g., 110). To address this mismatch, fuel system 14 can include a fuel level interface circuit 130. To illustrate that circuit's function, at step 134, fuel level interface circuit 130 can receive first signal 126 and produce a third signal 138 corresponding to the first signal. The third signal can, for example, include a voltage, current, and/or be indicative of a resistance that is understandable by the ECM(s) as corresponding to a fuel level to be displayed by fuel gauge 106. To illustrate, first signal 126 can be a (e.g., 0-16 VDC, square wave) PWM input, and third signal 138 can be indicative of a resistance (e.g., an effective resistance) between fuel level interface circuit 130 and one or more of the ECM(s), such as a resistance that is between 33 and 240 ohms.

As a non-limiting example, fuel level interface circuit 130 can comprise or act as a variable resistor, with a resistance that varies based upon first signal 126 (e.g., a duty cycle thereof) that the fuel level interface circuit receives. In some instances, third signal 138 can be generated in response to a signal—in addition to first signal 126—such as a signal sent by one or more of the ECM(s) to read the resistance of fuel level interface circuit 130. In other instances, fuel level interface circuit 130 can generate third signal 138 (e.g., a voltage and/or current that indicates to one or more of the ECM(s) the resistance of the fuel level interface circuit) without receiving such an additional signal.

The correspondence between first signal 126 and third signal 138 can be known, whether through the structure of fuel level interface circuit 130 or as stored in a memory, and that correspondence can be adjustable. Fuel level interface circuit 130 can, but need not, include a processor. And while shown as a separate component in FIG. 6, in some embodiments, fuel level interface circuit 130 can be part of fuel system processor 58, or the fuel system processor's first signal 126 can be understandable by the ECM(s) such that the fuel level interface circuit can be omitted.

At step 142, ECM(s) 62 and/or 66 can receive the third signal (or the first signal, as described above) and transmit a second signal 148 that corresponds to a fuel level to be displayed on gauge 106. Second signal 148 can be, for example, a CAN or other vehicle bus signal. That second signal can then be received by fuel system processor 58.

At step 152, gauge 106's reading can be calibrated. For instance, fuel system processor 58 can adjust or generate a correspondence-such as in a table or function stored in a memory—between first signal 126 and the fuel level in tank(s) 18 such that the fuel level in tank(s) 18 corresponding to the first signal is substantially the same as the fuel level to be displayed on gauge 106 corresponding to second signal 148. Similarly, fuel level interface circuit 130 (e.g., a processor thereof) can adjust or generate a correspondence between first signal 126 and third signal 138 such that the fuel level in tank(s) 18 corresponding to the first signal is substantially the same as the to-be-displayed fuel level corresponding to second signal 148. These approaches are not mutually exclusive; for example, fuel levels in tank(s) 18 can be substantially matched to fuel levels to be displayed on gauge 106 by adjusting or generating a correspondence between first signals 126 and the fuel levels in the tank(s) and adjusting or generating a correspondence between first signals 126 and third signals 138, where those correspondences, together, align the fuel levels in the tank(s) 18 with the to-be-displayed fuel levels.

Such correspondence(s) need not exist at the beginning of the calibration; instead, they can be generated during the calibration. To illustrate, fuel system processor 58 can send a first signal 126 before the first signal corresponds to a fuel level in tank(s) 18 and, after receiving second signal 148, generate a correspondence between the first signal and a fuel level in the tank(s) that is substantially the same as the to-be-displayed fuel level indicated by the second signal. This is possible, in part, because the fuel level in tank(s) 18 is determinable, such as based on fuel temperature and pressure indicated in data captured by sensor(s) 70, which can be mapped to a first signal 126 by fuel system processor 58.

First signals 126 (e.g., after calibration) can comprise a plurality of first signals that correspond to a plurality of fuel levels to be displayed by gauge 106, including a fuel level that is within 10% (e.g., within 9, 8, 7, 6, 5, 4, 3, 2, or 1%) of an empty fuel level of the tank(s), a fuel level that is within 10% (e.g., within 9, 8, 7, 6, 5, 4, 3, 2, or 1%) of a full fuel level of the tank(s), and a plurality of fuel levels therebetween (e.g., 5, 6, 7, 8, 9, 10, or more fuel levels therebetween). Calibration of gauge 106 can involve sending a first signal 126, and if a responsive second signal 142 is received that indicates a fuel level to be displayed by gauge 106, mapping that first signal to that fuel level in tank(s) 18. It can additionally or alternatively involve targeting fuel levels. Specifically, fuel system processor 58 can target each of one or more of these fuel levels and vary a first signal 126 until the targeted fuel level is substantially the same as a to-be-displayed fuel level indicated by a responsive second signal 148 and then map the first signal to the targeted fuel level. In any embodiment, a fuel level (e.g., in tank(s) 18, indicated by a first signal 126) can substantially be the same as or substantially match a fuel level (e.g., to be displayed by gauge 106, indicated by a second signal 148) if the fuel levels are within 10, 9, 8, 7, 6, 5, 4, 3, 2, 1, or less % of one another.

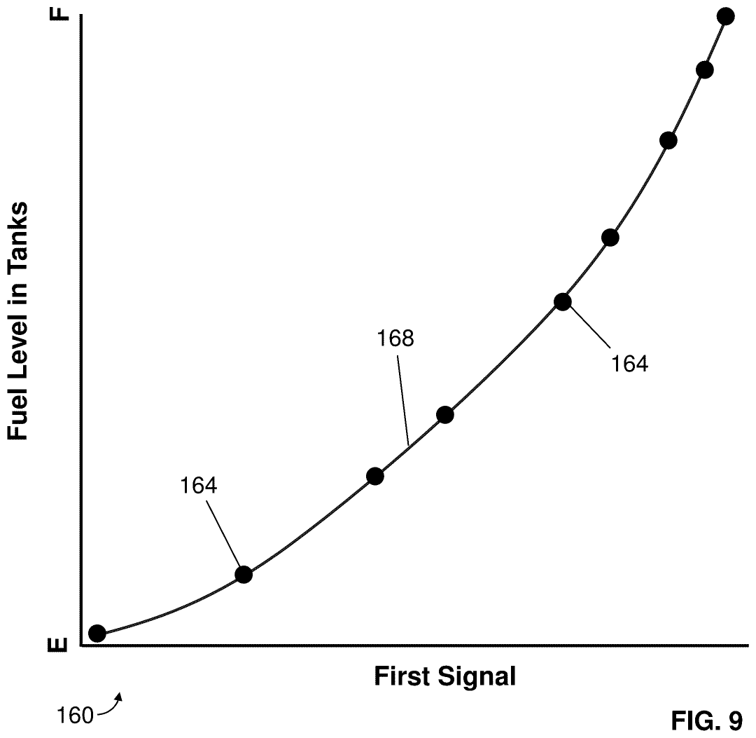

Referring additionally to FIG. 9, an illustrative correspondence 160 between the fuel level in tank(s) 18 and first signals 126 is shown. After sending a first signal 126, the first signal can be mapped to a fuel level in tank(s) 18 that is substantially the same as the to-be-displayed fuel level corresponding to the received second signal 148 as described above. These mappings can be in the form of points 164 and can be connected by a fit line 168, such as a polynomial fit line. Using this fit line, fuel system processor 58 can transmit a first signal 126 based on a known fuel level within tank(s) 18 (e.g., based on fuel temperature and pressure within the tank(s)) that results in a second signal 148 corresponding to a to-be-displayed fuel level on gauge 106 that substantially matches the fuel level within the tank(s).

Whatever its form, correspondence 160 can be stored in a memory, such as in a memory of gauge 74. This correspondence can subsequently be applied to other fuel systems that are otherwise similar to fuel system 14, including into a gauge (e.g., 74) thereof or other memory accessible by a fuel system processor (e.g., 58) thereof, meaning the calibration routine described above need not be repeated for such other fuel systems. Further, while the above fuel gauge calibration is described as in response to a user input via vehicle-mounted gauge 74, such is not required. In other embodiments, this fuel gauge calibration can be initiated and performed in other ways, including through the use of (other) on- and/or or off-vehicle equipment.

The above specification and examples provide a complete description of the structure and use of illustrative embodiments. Although certain embodiments have been described above with a certain degree of particularity, or with reference to one or more individual embodiments, those of ordinary skill in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the ones shown may include some or all of the features of the depicted embodiments. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means plus- or step-plus-function limitations, unless such a limitation is explicitly recited in a given claim using the phrase(s) “means for” or “step for,” respectively.

1. A system including:
a gauge configured to be mounted to a vehicle having a compressed gas fuel system including a compressed gas fuel tank, the gauge having a user interface configured to:
display fuel pressure within the fuel tank; and
receive a first user input to initiate diagnostic testing of the fuel system; and
one or more processors configured to, in response to the first user input:
actuate one or more components of the fuel system, including a solenoid and/or a relay; and
display, on the user interface, diagnostic information associated with the actuated one or more components.

2. The system of claim 1, wherein the one or more processors are configured to authenticate a user before responding to the first user input.

3. The system of claim 1 or 2, wherein:
the user interface is configured to receive a second user input; and
the one or more processors are configured to, in response to the second user input, display one or more parameters of the fuel system, including a cabinet temperature, a fuel temperature, an engine inlet pressure, and/or an engine load.

4. The system of any of claims 1-3, wherein:
the user interface is configured to receive a third user input; and
the one or more processors are configured to, in response to the third user input, calibrate a fuel level display of the vehicle.

5. The system of claim 4, wherein the fuel level display is displayed on a fuel gauge of the vehicle that is distinct from the gauge.

6. The system of claim 4 or 5, wherein the one or more processors are configured to calibrate the fuel level display at least by:
generating a plurality of first signals; and
for each of at least some of the first signals:
receiving a second signal generated by the vehicle based on the first signal and corresponding to a fuel level to be displayed on the fuel level display; and
associating the first signal with a fuel level in the tank that is substantially the same as the fuel level to be displayed on the fuel level display corresponding to the second signal.

7. The system of any of claims 1-6, wherein:
the user interface is configured to receive a third user input; and
the one or more processors are configured to, in response to the third user input, activate or deactivate one or more sensors of the fuel system.

8. The system of claim 7, wherein the user interface is configured to display data captured by the one or more sensors.

9. The system of any of claims 1-8, wherein the user interface is configured to:
display a fuel pressure downstream of a regulator of the fuel system; and
indicate whether the fuel pressure downstream of the regulator is above or below a target fuel pressure.

10. The system of claim 9, wherein the target fuel pressure is based at least in part on the fuel pressure within the fuel tank.

11. The system of any of claims 1-10, wherein the gauge is mounted to the vehicle.

12. The system of claim 11, wherein the gauge is positioned outside of a cab of the vehicle.

13. A method for diagnosing a fuel system of a vehicle, the method comprising:
displaying, via a user interface of a gauge mounted to the vehicle, the vehicle having a compressed gas fuel system including a compressed gas fuel tank, a fuel pressure within the fuel tank;
receiving, via the user interface, a first user input to initiate diagnostic testing of the fuel system;
actuating, in response to the first user input, one or more components of the fuel system, including a solenoid and/or a relay; and
displaying, on the user interface, diagnostic information associated with the actuated one or more components.

14. The method of claim 13, comprising authenticating a user before responding to the first user input.

15. The method of claim 13 or 14, comprising:
receiving, via the user interface, a second user input; and
in response to the second user input, displaying one or more parameters of the fuel system, including a cabinet temperature, a fuel temperature, an engine inlet pressure, and/or an engine load.

16. The method of any of claims 13-15, comprising:
receiving, via the user interface, a third user input; and
in response to the third user input, calibrating a fuel level display of the vehicle.

17. The method of claim 16, comprising displaying the fuel level display on a fuel gauge of the vehicle that is distinct from the gauge.

18. The method of claim 14 or 15, wherein calibrating the fuel level display comprises:
generating a plurality of first signals; and
for each of at least some of the first signals:
receiving a second signal based on the first signal and corresponding to a fuel level to be displayed on the fuel level display; and
associating the first signal with a fuel level in the tank that is substantially the same as the fuel level to be displayed on the fuel level display corresponding to the second signal.

19. The method of any of claims 13-18, comprising:
receiving, via the user interface, a third user input; and
in response to the third user input, activating or deactivating one or more sensors of the vehicle.

20. The method of claim 19, comprising displaying on the user interface data captured by the one or more sensors.

21. The method of any of claims 13-20, comprising:
displaying, on the user interface, a fuel pressure downstream of a regulator of the fuel system; and
indicating, on the user interface, whether the fuel pressure downstream of the regulator is above or below a target fuel pressure.

22. The method of claim 21, wherein the target fuel pressure is based at least in part on the fuel pressure within the fuel tank.

23. The method of any of claims 13-22, wherein the gauge is positioned outside of a cab of the vehicle.
